(19) United States
(12) Patent Application Publication
(10) Pub. No.: US 2020/0079450 A1
(43) Pub. Date: Mar. 12, 2020

(54) DEVICE FOR ADJUSTING A FIRST COMPONENT AND A SECOND COMPONENT RELATIVE TO EACH OTHER IN A PASSENGER OR FREIGHT TRANSPORT MEANS AND A PASSENGER AND/OR FREIGHT TRANSPORT MEANS WITH SUCH A DEVICE

(71) Applicants: MOTHERSON INNOVATIONS COMPANY LIMITED, London (GB); ILLINOIS TOOL WORKS INC., Glenview, IL (US)

(72) Inventors: Eric Fischer, Freiburg (DE); Claus Bleile, Schallstadt (DE); Dieter Gut, Vogtsburg-Oberbergen (DE); Victor Diez Herrera, Sabadell ( Barcelona) (ES); Thiemo Ammann, Rockenhausen (DE)

(73) Assignees: MOTHERSON INNOVATIONS COMPANY LIMITED, London (GB); ILLINOIS TOOL WORKS INC., Glenview, IL (US)

(21) Appl. No.: 16/568,494

(22) Filed: Sep. 12, 2019

(30) Foreign Application Priority Data
Sep. 12, 2018 (EP) 18 194099.0

(51) Int. Cl. B62D 65/02; B62D 65/16

(52) U.S. Cl. CPC B62D 65/026; B62D 65/16

(57) ABSTRACT

An adjusting device is proposed for adjusting a first component and a second component of a passenger or freight transport vehicle relative to each other, wherein the two components are arranged adjacent to each other to form a gap. The device includes a base body, an adjusting element mounted in the base body and movable along a first axis and an actuating body mounted in the base body and movable along a second axis which cooperates with the adjusting element such that the movement of the adjusting element along the first axis converted into a movement of the actuating body and/or the adjusting element along the second axis; and a fixing device for fixing the adjusting element and the actuating body in a selectable position. The invention also relates to a passenger or freight transport vehicle with such a device.

### CROSS-REFERENCES TO RELATED APPLICATIONS

This application claims the priority of European Patent Application Serial No. 18 194099.0, filed Sep. 12, 2018, pursuant to 35 U.S.C. 119(a)-(d), the subject matter of which is incorporated herein by reference.

### BACKGROUND OF THE INVENTION

The present invention relates to a device for adjusting a first component and a second component of a passenger and/or goods transport means relative to each other. Furthermore, the invention relates to a passenger and/or freight transport means with such a device.

The passenger and/or freight transport means is designed in particular as a vehicle and may also be a ship, an aircraft, a train or the like. In the following, when the invention is explained in relation to vehicles, the statements equally apply to other passenger and/or freight transport means such as ships, aircraft, trains or the like.

The standard of quality, which is particularly important in the case of vehicles as a sales argument, is also shown in the uniform and small degree of visible gaps with which two adjacent components, for example the motor hood, the headlight and the bumper, are arranged adjacent to one another in vehicles. Due to fluctuations in production, however, the components are never exactly the same size, so that sets a different gap dimension for each vehicle. In order nevertheless to obtain a uniform gap dimension, the gap dimension is proceeded separately for each vehicle in the following manner: At least one of the two adjacently arranged components is mounted to a certain extent movable on the vehicle. The movement is usually generated by means of an eccentric disc, which is rotatably arranged between the movable member and a support on which the movable member is supported. By rotating the eccentric disk, the component in question can be moved towards or away from the component arranged adjacent to it. As a result, the gap dimension can be adjusted.

To move the component in question to the adjacent component arranged to move or move away from this, by means of the eccentric disc, it requires normally a comparatively high effort, which must be applied by the relevant employee of the vehicle manufacturer. Usually, the eccentric disc has a receptacle for a wrench, with which the employee can apply the necessary force for this purpose. However, since the force is relatively high, the gap dimension must be set very accurately, which can take a considerable amount of time setting the gap dimension as specified. Furthermore, the effectiveness of the eccentric disc is low. In addition, the eccentric disc tends to adjust as a result of the vibrations occurring during operation of the vehicle, which also changes the set gap dimension.

The EP 2 683 596 A1 discloses a device for adjusting the gap dimension without an eccentric disc, however, it cannot be reliably prevented with the device shown there, that a once set gap dimension changes during operation of the vehicle.

It would therefore be desirable and advantageous to provide an improved device to obviate prior art shortcomings and to provide solutions to the shortcomings in the prior art.

### SUMMARY OF THE INVENTION

According to one aspect of the present invention a device is provided with which it is possible with simple and inexpensive means to adjust the gap dimension a first component and a second component of a passenger and/or goods transport in a short time as specified, which once adjusted gap dimension should also be maintained under the vibrations occurring during operation. Furthermore, one embodiment of the present invention is based on the object of providing a passenger and/or freight transport vehicle with such a device.

This object is achieved with the following features with advantageous embodiments being the subject of the dependent claims.

One embodiment of the present invention relates to a device for adjusting a first component and a second component of a passenger and/or freight transport means relative to one another, wherein the two components are arranged adjacent to one another to form a gap, including a base body, an adjusting element mounted in the base body and movable along a first axis and/or about the first axis, and an actuating body mounted in the base body and movable along a second axis which cooperates with the adjusting element such that the movement of the adjusting element along the first axis or about the first axis is converted into a movement of the actuating body and/or the adjusting element along the second axis, wherein the movement of the actuating body and/or of the adjusting element along the second axis is transferable to the first component or the second component, and a fixing device for fixing the adjusting element and the actuating body is in a selectable position.

An adjusting element is to be understood as meaning an element which can be operated by a person, for example by an employee of the manufacturer of the transport vehicle or a repair workshop, preferably with a suitable tool. The actuating body converts the movement of the adjusting element along the first axis and/or about the first axis into a movement along the second axis.

According to the present invention, two units cooperate in the device, namely the adjusting element and the actuating body. The interaction can be designed such that a translation in the conversion of the movement of the adjusting element is effected in the movement of the actuating body. This makes it possible to keep the force required for adjusting the first component and the second component relative to each other low. In addition, the device according to the present invention includes the fixing device, with which the position of the adjustment element and the actuating body can be fixed in a selectable position. It follows, that the two relatively movable components cannot move relative to each other once the position of the adjusting element and the actuating body has been fixed. As mentioned above, the gap dimension can shift in known passenger and/or freight transport vehicles due to loads and vibrations occurring during operation. Such a shift in the operation of the passenger and/or goods transport means is prevented by means of the fixing device. As a result, the once set gap dimension is retained. The above-mentioned quality standard of the vehicle with respect to the gap dimension is therefore not negatively impacted.

According to a further embodiment, the adjusting element is designed as a screw with a screw head. Screws are a widely used means to convert a rotary motion into a longitudinal motion. They are inexpensive and easy to use. In order to prevent the screw from loosening under the stresses and vibrations occurring during operation and to perform an uncontrolled rotation, the screw can be secured, for example, with spring washers or other screw locking elements, which in this case act as a fixing device.

In a further developed embodiment, the fixing device may be formed as a self-locking thread of the screw. The threads commonly used in screws are anyway self-locking, which does not preclude that the screws in question can rotate uncontrollably during operation. In this embodiment, the thread can be made self-locking to a particular extent, for example, by the fact that the pitch of the thread is particularly low. In this case, the screw acts not only as the adjusting element, but at the same time as the fixing device, so that the device according to this embodiment requires only a few components and therefore has a low complexity.

According to a further embodiment, the adjusting body is rotatably mounted in the base body via a cantilever movable about a pivot point, in particular about a directed fulcrum perpendicular to the first axis and the second axis. The adjusting body has a first contact surface for acting through the screw head of the screw, which is aligned substantially perpendicular to the first axis, and a second contact surface for contacting the first component or the second component, which is aligned substantially perpendicular to the second axis. As a result, a directional deflection of the adjustment is achieved in a simple manner. For this purpose, the base body in particular has an internal thread matching the screw, which is aligned in the direction of the first axis. In particular, the actuating body has an opening for the passage of the screw, and the first contact surface is formed by the surface surrounding the opening.

In accordance with a further embodiment, the adjusting body has at least two, in particular, an approximately L-shaped actuating body forming legs, which are angled to each other in the range of 45° to 135°, in particular approximately 90°, wherein the pivot point in the connection point of the two Leg is arranged and wherein the first contact surface is formed on the one leg and the second contact surface on the other leg. As a result, a corresponding actuating body is realized in a simple manner.

A further embodiment is wherein at least one, preferably both, of the first and second contact surfaces are convexly curved, thereby causing the respective contact surface to be aligned substantially perpendicular to the first axis or second axis even in different rotational positions about the pivot point. As a result, the contact with the component or the screw is improved.

According to another embodiment, the first contact surface is arranged at a different, in particular, smaller distance from the point of rotation than the second contact surface. In this way, an advantageous translation can be determined by fixing the different distances.

In yet a further development, the adjusting element in that embodiment may be formed as a screw, wherein the adjusting body is designed as a screw on the particular fixedly arranged eccentric body. The eccentric body makes it possible to design the actuator space-saving and simple. In this way, the entire device can be made compact and also be arranged where the available space is limited.

In a further embodiment, the eccentric body can have a helical bearing surface with a radius that changes with respect to the first axis, the eccentric body being supported on a bearing section of the basic body. In this embodiment, a particularly good guidance of the eccentric body is provided with respect to the base body, whereby the two components to be adjusted relative to each other can also be moved very precisely. The gap dimension can therefore be set very accurately.

A further developed embodiment is wherein the fixing device comprises a friction section arranged on the main body and cooperating with the eccentric body. In this embodiment, the fixing device can be designed to be particularly simple, namely the fact that the eccentric body is pressed against the friction portion of the body. Consequently, a friction force must be overcome, which prevents the screw rotating uncontrollably during operation of the passenger and/or freight transport and changes the set gap dimension.

According to a further embodiment, wherein the adjusting element comprises a spindle and the actuating body comprises a spindle nut arranged on the spindle and a scissor pair with two scissor members, wherein the spindle nut is non-rotatably secured to the scissor pair, wherein the first of the scissor members is rotatably fastened on the base body and the other of the scissors members is rotatably fastened with a support body, on which the first component or the second component can be placed, or the first of the scissor members rotatably attached to the base body and the other of the scissor members can be fastened non-rotatably on the first component or the second component. The use of the scissor pair makes it possible to move the component in question very precisely relative to the second component. The gap dimension can therefore be adjusted very precisely. In addition, it is possible by means of the scissor pair to realize large ratios, so that even heavy components can be moved without an unreasonable force for the employees mounting the components relative to each other to set the desired gap size.

A further embodiment is wherein the adjusting element comprises a spindle and the adjusting body comprises a spindle wedge arranged on the spindle or about the spindle, and the base body has a wedge portion corresponding to the spindle wedge, wherein the spindle wedge is supported on the wedge portion or vice versa. The spindle wedge and the wedge portion each have a very simple geometric shape, so that this embodiment is characterized by a simple shape.

In addition, the spindle wedge and the corresponding wedge portion act as the fixing device, since a particularly high frictional force acts between them, which prevents an adjustment of the gap dimension during operation.

In a further developed embodiment, the fixing device has a blocking element which is non-rotatable and axially displaceable on the adjusting element, wherein the blocking element between a blocking position, in which the blocking element blocks the rotation of the adjusting element about the first axis, and an open position, in which the blocking element allows the rotation of the adjusting element, is axially displaceable. In this embodiment, the employee must first move the locking element from the blocking position to the open position when setting the gap dimension before he can move the two relevant components relative to each other and set the gap dimension. If the intended gap dimension is reached, the employee puts the blocking element back into the locking position, in which rotation of the adjusting element is prevented. As a result, it is also prevented that the two components in question can move relative to each other during operation and changes the gap dimension.

According to a further embodiment, the adjusting element is designed as a gear rotatably mounted in the base body, which is in mesh with the actuating body arranged as a rack movable along the second axis. By means of the gearwheel and the gear meshing with the gear meshing gear large translation ratios can be provided in a small space, so that heavier components can be brought to the intended gap size, without an unreasonable amount of force to be applied by the employee assembling these components.

According to a further developed embodiment, a rotatably mounted in the main body intermediate gear is disposed between the gear and the rack. Also, the idler gear serves to increase the gear ratios and thereby make the setting of the gap dimension for the employee particularly easy.

In addition, it can be provided in a further embodiment that the gear is formed as a bevel gear. By means of the bevel gear, the accessibility of the adjusting element can be selected according to the requirements of the production. In addition, it is also possible to use the proposed device in hard to reach places, so that components can be brought to the desired gap dimension whose gap dimension was not yet adjustable. As a result, the quality impression of the passenger and/or freight transport means concerned can be further increased.

A further embodiment is wherein the gear is mounted axially displaceable in the main body, wherein the gear between a blocking position in which the rotation of the adjusting element is locked about the first axis, and an open position in which the rotation of the adjusting element is possible, is axially displaceable. In this embodiment, the employee must first move the gear from the locking position to the open position when setting the gap dimension before he can move the two relevant components relative to each other and adjust the gap dimension. If the intended gap dimension is reached, the employee puts the gear back in the blocking position, in which rotation of the adjusting element is prevented. As a result, it is also prevented that the two components in question can move relative to each other during operation and changes the gap dimension.

According to a further embodiment, the base body has a locking portion corresponding to the toothed wheel, in which the toothed wheel engages positively in the locking position. The locking portion can be particularly easy to manufacture in this embodiment.

An embodiment of the invention relates to a passenger and/or goods transporting means, comprising a first component and a second component, wherein the two components are arranged adjacent to each other to form a gap, and a device according to one of the previously described embodiments, wherein the first component and the second component by means of the device are adjustable relative to each other, whereby the gap dimension of the gap is variable.

The technical effects and advantages that can be achieved with the present invention for a passenger and/or freight transport vehicle, correspond to those that have been discussed for the present device for adjusting a first component and a second component. In summary, it should be noted that on the one hand, the gap dimension can be set with a small force as specified, even if the component to be moved is relatively heavy. On the other hand, it is prevented by means of the fixing device that the once set gap dimension changes uncontrollably due to the vibration and loads occurring during operation of the passenger and/or goods transport.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic sectional view of a first component and a second component of a passenger and/or goods transport means and a device according to the invention, with which the components are adjustable relative to each other,

FIG. 2 is a schematic representation of a first embodiment of a device according to the present invention,

FIGS. 3A and 3B show a second exemplary embodiment of a second exemplary embodiment of the device according to the present invention on the basis of a perspective illustration or a side view,

FIG. 4 shows a third embodiment of the device according to the present invention with reference to a side view,

FIG. 5A shows a fourth exemplary embodiment of the device according to the present invention with reference to a side view,

FIG. 5B shows an enlarged detail of the fourth exemplary embodiment shown in FIG. 5A,

FIG. 6 shows a fifth embodiment of the device according to the present invention with reference to a side view,

FIG. 7 shows a sixth embodiment of the device according to the present invention with reference to a side view,

FIG. 8A shows a seventh exemplary embodiment of the device according to the present invention with reference to a side view,

FIG. 8B shows a perspective isolated view of the spindle part of the device according to FIG. 8A,

FIG. OA is a schematic side view of an eighth embodiment of the device according to the present invention,

FIG. 98B is a schematic sectional view of the eighth exemplary embodiment shown in FIG. 9A, along the sectional plane A-A defined in FIG. 9A, the device according to the present invention being in an open position,

FIG. 9C shows the eighth exemplary embodiment shown in FIG. 9A also along the sectional plane A-A defined in FIG. 9, the device according to the present invention being in a blocking position,

FIG. 10A is a ninth embodiment of the device according to the invention with reference to a perspective view,

FIG. 10B is a partial sectional view of the ninth embodiment shown in FIG. 10A, wherein the device according to the present invention is in a blocking position, and

FIG. 10C is a partial sectional view of the ninth embodiment, wherein the device according to the invention is in an open position.

### DETAILED DESCRIPTION OF PREFERRED EMBODIMENTS

Throughout all the Figures, same or corresponding elements are generally indicated by same reference numerals.

FIG. 1 shows a passenger and/or freight transporting means 10 on the basis of a basic illustration, which has a first component 12 and a second component 14. In all exemplary embodiments described below, the passenger and/or freight transport means 10 should be designed as a vehicle 16, in particular as a motor vehicle, but the following embodiments are essentially also for other embodiments of the passenger and/or freight transport means 10 such as trains, ships or aircraft and thus apply in the same manner.

The first component 12 may, for example, be a bumper or a headlight, whereas the second component 14 may be, for example, an engine hood. The first component 12 and the second component 14 are arranged adjacent to the formation of a gap 18 with the gap dimension G, the gap 18 is visible from the outside. The first component 12 is attached to the vehicle 16 rotatably about an attachment point B, wherein an axially displaceable mounting is also conceivable. Furthermore, the first component 12 has a projection 20 which cooperates with a device 22 according to the invention for adjusting the first component 12 relative to the second component 14. In the example shown, the second component 14 should be located above the first component 12 with respect to the intended orientation of the vehicle 16. Referring to FIG. 1, the device 22 is supported downwardly on a carrier 24 of the vehicle 16.

The distance of the gap 18 forming part of the first component 12 to the attachment point B is selected so that due to the operation of the device 22 according to the invention mainly causes a movement of the first member 12 in the Z direction, whereby the gap dimension G of the gap 18 can be changed accordingly. Usually, the gap dimension G is less than 1 cm. Due to the fact that the second component 14 is arranged above the first component 12, the first component 12 must be moved against the gravitational force. Consequently, the setting of the gap dimension G is particularly difficult in this case. However, the device 22 according to the invention can likewise be used for the case in which the first component 12 and the second component 14 are arranged next to one another or in different orientations relative to one another.

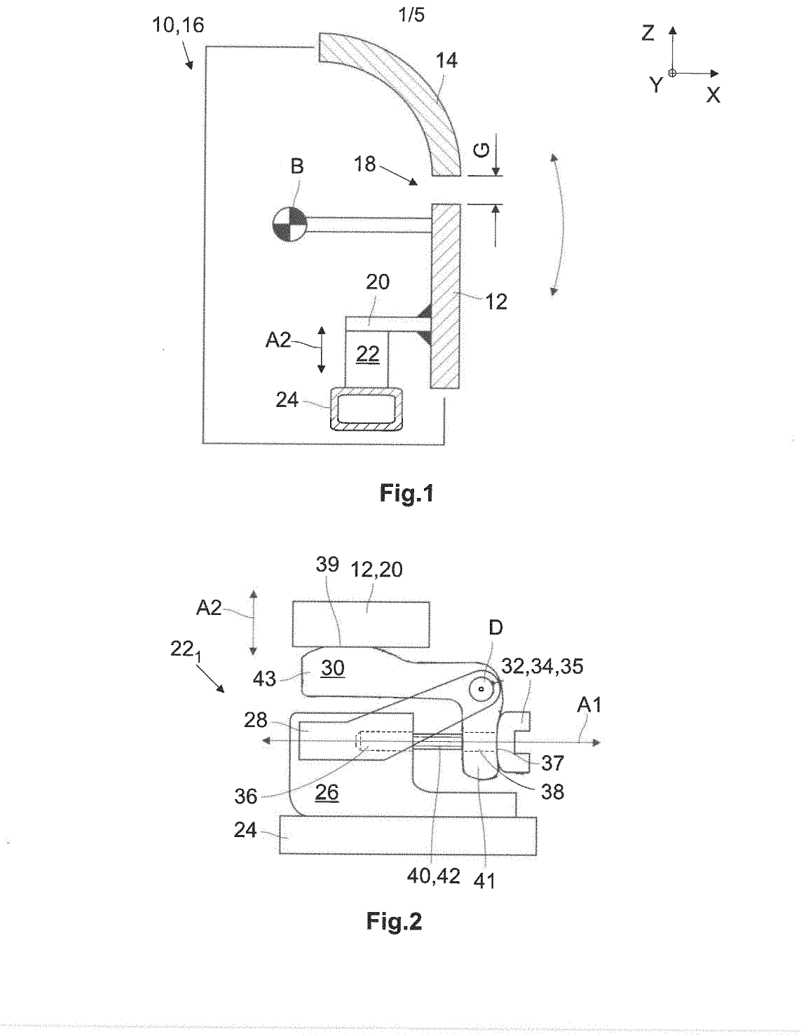

FIG. 2 shows a first exemplary embodiment of the device 22₁, according to the invention on the basis of a basic side view. The device 22₁ comprises a main body 26, which rests on the already mentioned carrier 24, so that the device 22₁ can be supported on the carrier 24. Furthermore, a cantilever 28 is attached to the base body 26, to which an L-shaped actuating body 30 is rotatably mounted about a pivot point D, wherein the pivot point D can also be understood as a rotation axis D. In the case shown, the cantilever 28 is formed as a separate component, wherein it may also be formed as an integral part of the base body 26, so that the base body 26 is in one piece. The actuating body 30 rests against the already described projection 20 of the first component 12 at its upper end (see FIG. 1). In addition, the device 22₁, according to the present invention in accordance with the first embodiment comprises an adjusting element 32, which is designed as a screw 34, rotatable about a first axis A1. The screw 34 is partially screwed into a threaded bore 36 arranged in the base body 26. In addition, the screw 34 is inserted through a through hole 38 of the actuating body 30, wherein the screw head 35 of the screw 34 rests against the actuating body 30.

The actuating body 30 has a first contact surface 37 for acting on the screw head 35 of the screw 34, which is aligned substantially perpendicular to the first axis A1. Furthermore, the adjusting body 30 has a second contact surface 39 for contacting the first component 12, which is aligned substantially perpendicular to the second axis A2.

The actuating body 30 has in the first embodiment, two legs 41, 43, which give the actuator body 30 an approximately L-shaped configuration. The two legs 41, 43 are angled approximately at 90° to each other, wherein the pivot point D is arranged in the connecting region of the two legs 41, 43 and wherein the first contact surface 37 is formed on one leg 41 and the second contact surface 39 formed on the other leg 43.

In the first exemplary embodiment, both the first contact surface 37 and the second contact surface 39 are convexly curved, which causes the respective contact surface 41, 43 to be substantially perpendicular to the first axis A1 or the second axis A2, even in different rotational positions about the pivot point D. In addition, the first contact surface 37 is arranged at a smaller distance from the pivot point D than the second contact surface 39.

In addition, the device according to the present invention 22₁ according to the first embodiment, a fixing device 40, which causes the once set position of the adjusting element 32 and consequently of the actuating body 30 to be fixed so that it does not change even under load during operation of the vehicle 16. In the exemplary embodiment shown, the fixing device 40 comprises a self-locking thread 42 arranged on the screw 34, but alternatively or cumulatively, it may comprise, for example, spring washers or other screw locking elements, not shown.

If the gap dimension G of the gap 18 shown in FIG. 1 is to be changed between the first and the second component 12, 14, the procedure is as follows: The screw 34 is rotated about the first axis A1 with a suitable tool. Depending on the direction of rotation, the screw 34 is further screwed into the threaded bore 36 or moved out of it, so that the screw 34 is moved along the first axis A1. As a result, a rotation of the actuating body 30 is effected. The pivot point D and the orientation of the actuating body 30 are selected so that the rotational movement about the pivot point D in the relevant area here has mainly an axial movement of the actuating body 30 along a second axis A2, which is perpendicular to the first axis A1. Referring to FIG. 1, the second axis A2 coincides with the Z direction. The rotation of the actuating body 30 causes the first component 12 to move either toward the second component 14 or away from the second component 14. As a result, the gap dimension G is reduced or increased. Consequently, it is possible to set the gap dimension G by turning the screw 34 as predetermined. Due to the fact that the screw 34 has the self-locking thread 42, this remains in a once-selected position without uncontrolled rotation, for example, due to vibrations and loads that occur during operation of the vehicle 16. The once set Gap dimension G therefore does not change.

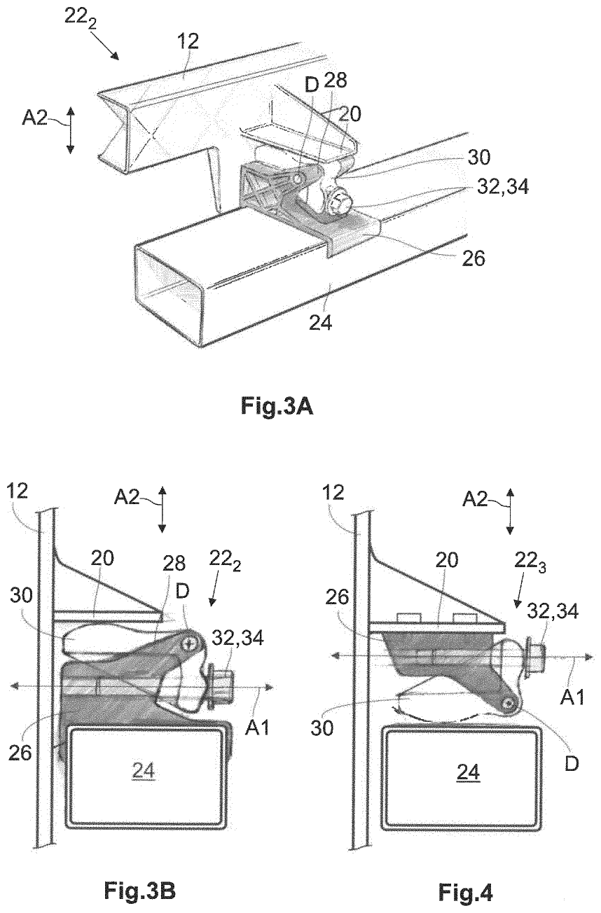

FIGS. 3A and 3B show a second exemplary embodiment of the device 22₂ according to the present invention with reference to a perspective view and a side view, respectively. The device according to the invention 22₁, according to the second embodiment substantially corresponds to the first embodiment; however, in this case, the cantilever 28 is formed in one piece with the base body 26.

FIG. 4 shows a third exemplary embodiment of the device 22₃ according to the invention on the basis of a side view. The basic structure of the device 22₁ according to the present invention according to the third embodiment is similar to that of the inventive device 22₁, 22₂ according to the first and the second embodiment, however, the device 22₃ is rotated by 180° mounted in the vehicle 16. As a result, the base body 26 is secured in this case to the projection 20 of the first component 12 and therefore does not support itself on the carrier 24 of the vehicle 16. Furthermore, the adjusting body 30 does not bear on the projection 20 of the first component 12, but on the carrier 24 of the vehicle 16. The adjustment of the gap dimension G is carried out in the manner described above.

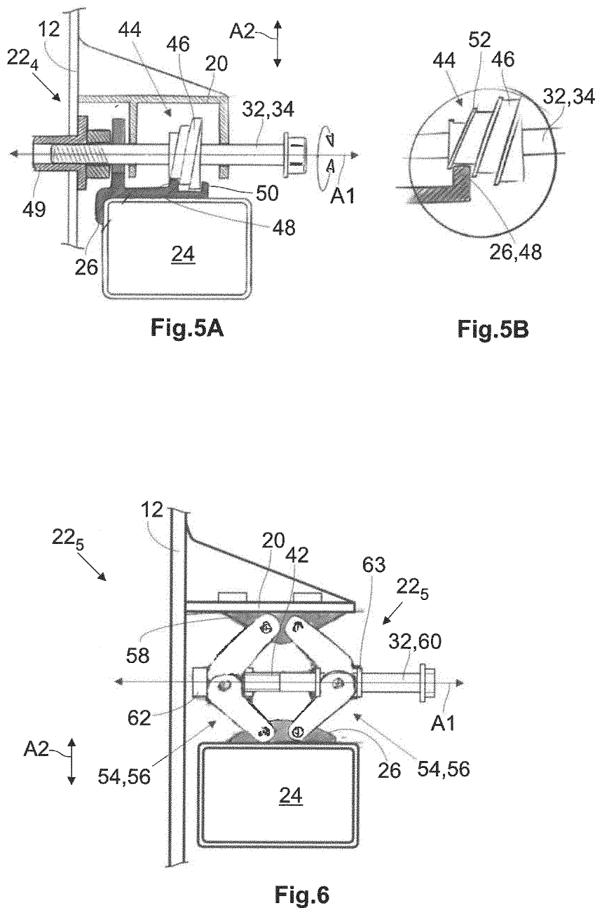

FIG. 5A shows a fourth exemplary embodiment of the device 22₄ according to the invention on the basis of a side view. In this case, the actuating body 30 is configured as a rotationally fixed and axially non-displaceable eccentric body 44 on which a screw 34 configured as an adjusting element 32 is mounted and rotatable about the first axis A1 and mounted on eccentric body 44. The eccentric body 44 has a helical bearing surface 46, the radius of which increases in relation to the first axis A1 and to the representation selected in FIG. 5A from left to right along the first axis A1. The base body 26 has a support section 48 with which the eccentric body 44 is in contact with the support surface 46 with the base body 26. The screw 34 is screwed into a threaded sleeve 49 inserted into the first component 12, however, the pitch of the thread of the threaded sleeve 49 is adapted to the pitch of the support surface 46 of the eccentric body 44, so that in this embodiment, the thread of the threaded sleeve 49 depending on the pitch of the support surface 48 cannot be designed self-locking. Depending on the embodiment, consequently, the thread of the threaded sleeve 49 cannot take over the function of the fixing device 40. In order nevertheless to prevent the screw 34 from rotating in an uncontrolled manner, the eccentric body 44 rests with its end facing away from the threaded sleeve 49 against a friction section 50 which is formed by the main body 26.

To adjust the gap dimension G, the screw 34 is rotated in one or the other direction about the first axis A1. As a result, the screw 34 is further moved into the threaded sleeve 49 or out of the threaded sleeve 49 along the first axis A1. As a result of the changing radius of the support surface 46, the first component 12 is thereby moved along with the screw 34 and the eccentric body 44 along the second axis A2 away from the base body 26 and from the carrier 24 or towards the base body 26 and the carrier 24. The pitch of the thread of the threaded sleeve 49 is dimensioned so that the support portion 48 always remains on the support surface 46 of the eccentric body 44. As shown in FIG. 5B, the eccentric body 44 has elevations 52 which delimit the support surface 46 toward its free end, whereby the support section 48 is guided on the support surface 46.

As already mentioned, the friction section 50 of the main body 26 bears against the end of the eccentric body 44 pointing away from the threaded sleeve 49. Due to the frictional force acting between the friction portion 50 and the eccentric body 44, the screw 34 is prevented from rotating uncontrollably about the first axis A1. Consequently, in this embodiment, the friction portion 50 forms the fixing device 40.

FIG. 6 also shows a fifth exemplary embodiment of the device 22₅ according to the invention with reference to a side view. The actuating body 30 in this case comprises a scissor pair 54, each having two scissor members 56. Based on the representation selected in FIG. 6, the two lower scissor members 56 are rotatably connected to the base body 26 of the device 22₅, which is supported on the carrier 24 of the vehicle 16 shown in FIG. 1. The two upper scissor members 56 are rotatably connected to a support body 58 which is fixed to the projection 20 of the first component 12, also shown in FIG. 1. Alternatively, the projection 20 may have attachment portions, not shown here, to which the two upper scissor members 56 are attached. In addition, the scissor members 56 of a scissor pair 54 are rotatably connected to each other. All axes of rotation of the scissor pairs 54 are parallel and, with reference to the representation chosen in FIG. 6, perpendicular to the plane of the drawing. The adjusting element 32 in this case comprises a spindle 60, which penetrates the two scissor pairs 54. Furthermore, a spindle nut 62 is screwed onto the spindle 60 and rotatably connected to the left scissor pair 54 in FIG. 6.

To set the gap dimension G, the spindle 60 is rotated in one or the other direction about the first axis A1. As a result, the spindle nut 62 is moved in one or the other direction axially along the first axis A1 and transmits this movement to the left scissor pair 54. If the spindle 60 is moved so that the spindle nut 62 moves to the right relative to the FIG. 6, so, for example, the angle which the two scissor members 56 enclose with each other is increased, whereby the first member 12 is lifted along the second axis A2. As a result, the gap dimension G is reduced. In order to prevent the spindle 60 itself from moving along the first axis A1, the latter has an enlargement of diameter 63 which, for example, can be realized in the manner of a securing ring, with which the spindle 60 bears against the right-hand scissor pair. As an alternative to the securing ring, a second spindle nut 62, not shown here, can be provided, which moves in the direction of the first spindle nut 62 toward or away from the first spindle nut 62 upon rotation of the spindle 60. Such a movement can be achieved, for example, in that the spindle 60 has two threaded portions, of which the one threaded portion has a positive and the other threaded portion has a negative pitch. In any case, the spindle 60 has a self-locking thread 42, which represents the fixing device 40 in this embodiment and prevents that the spindle 60 can rotate uncontrollably about its own axis A1,

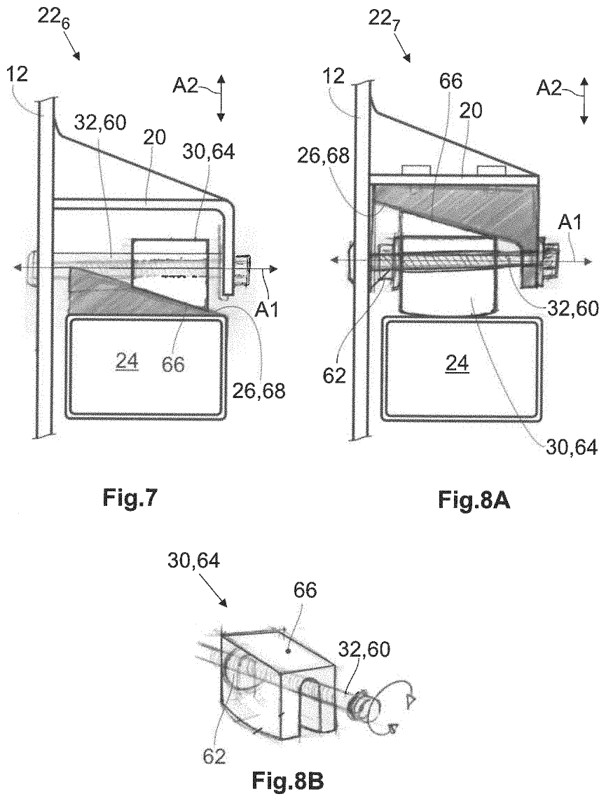

FIG. 7 shows a sixth exemplary embodiment of the device 22₆ according to the invention on the basis of a side view. The device 22₁, according to the sixth embodiment has a spindle 60 and a spindle wedge 64 arranged on the spindle 60. The spindle 60 forms the adjusting element 32 and the spindle wedge 64 forms the adjusting body 30. The spindle wedge 64 is formed in the manner of a spindle nut 62, however, has an inclined surface 66. With this inclined surface 66 of the spindle wedge 64 rests on a wedge portion 68 of the base body 26, which is formed corresponding to the spindle wedge 64 and in particular has the same inclination. If the spindle 60 is rotated about its own axis A1, the spindle wedge 64 moves along the axis of rotation of the spindle 60 and the first axis A1, whereby the first component 12 together with the spindle 60 and the spindle wedge 64 along the second axis A2 second component 14 is moved toward or away from the second component 14, whereby the gap dimension G is changed accordingly. In order to prevent the spindle 60 itself from moving along the first axis A1 during rotation, the projection 20 is L-shaped. The spindle 60 is based on the first axis A1 on the one hand against the free leg of the L-shaped projection 20 and on the other hand against the first component 12 at.

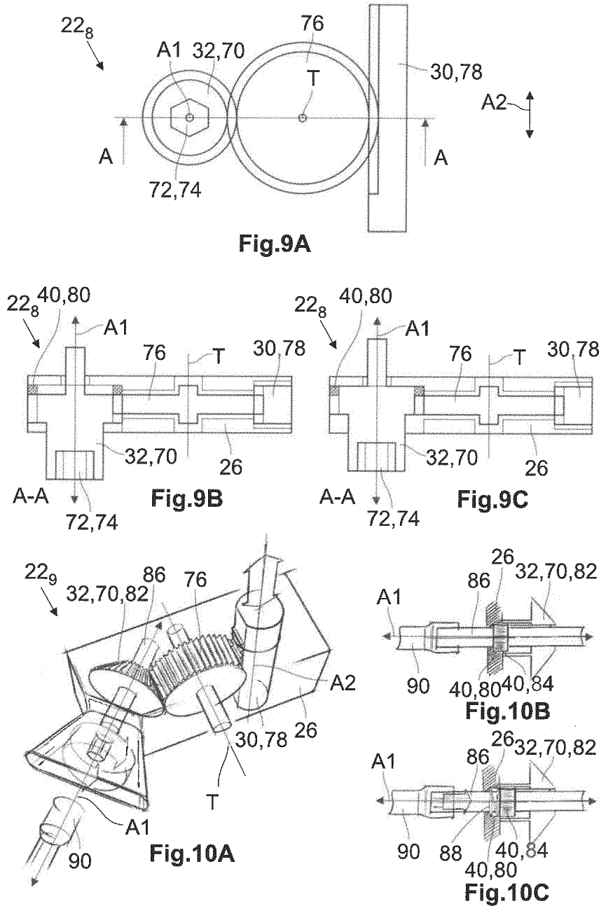

In FIG. 8A, a seventh embodiment of the device 22₇ according to the invention is shown with reference to a side view. The seventh exemplary embodiment largely resembles the sixth exemplary embodiment shown in FIG. 7, but the base body 26 is not arranged on the carrier 24 but on the projection 20 of the first component 12. The spindle wedge 64, which is shown separately in FIG. 8B on the basis of a perspective illustration, rests on the carrier 24 on and with the inclined surface 66 on the wedge portion 68 of the main body 26. In the seventh embodiment of the device 22₇ according to the invention, the spindle wedge 64 has no thread with which it interacts with the spindle 60. The movement of the spindle wedge 64 along the first axis A1 is instead effected with the spindle nut 62 screwed onto the spindle 60 which is rotatably connected to the spindle wedge 64. If the spindle 60 is rotated, the spindle wedge 64 is moved by means of the spindle nut 62 not only relative to the wedge portion 68 of the base body 26, but also relative to the carrier 24 along the first axis A1. As in the sixth embodiment, the spindle 60 is fixed to the first member 12 so that it cannot move along the first axis A1. The main body 26 is L-shaped, so that the spindle 60 on the free leg is also secured against displacement along the first axis A1.

Due to the fact that in both the sixth embodiment and in the seventh embodiment of the inventive device 22₆, 22₇ of the spindle wedge 64 is in contact with the wedge portion 68 of the base body 26, acts between the spindle wedge 64 and the wedge portion 68, a correspondingly high frictional force, which prevents in that the spindle wedge 64 can move uncontrollably relative to the wedge portion 68. Consequently, the spindle wedge 64 in the apparatus 22₆, 22₇ according to the sixth and the seventh embodiment acts as the fixing device 40. In the seventh embodiment, a frictional force additionally acts between the spindle wedge 64 and the carrier 24, so that the once set position of the adjusting element 32 and the adjusting body 30, in this case the spindle wedge 64, is additionally fixed.

FIGS. 9A, 9B and 9C show an eighth exemplary embodiment of the device 22₈ according to the invention on the basis of a principal side view. The adjusting element 32 is formed in this case as a gear 70 having an executed in the illustrated embodiment as a hexagon 72 engaging portion 74, in which a correspondingly shaped tool can be introduced. With this tool, the gear 70 can be rotated about the first axis A1 perpendicular to the plane of the drawing of FIG. 9A. The gear 70 is in meshing engagement with an intermediate gear 76 which can be rotated about a parallel to the first axis A1 of the first gear 70 extending further axis of rotation T. The further gear 70 is in meshing engagement with a rack 78 which is axially movable perpendicular to the first axis A1 and the further axis of rotation T along the second axis A2. The rack 78 is connected to the first component 12, not shown here, so that a rotation of the gear 70 about the first axis A1 causes a movement of the first component 12 to the second component 14 in or from the second component 14 away.

In FIGS. 9B and 9C, the device 22a is shown along the sectional plane A-A shown in FIG. 9A. 9B, the gear 70 is shown in an open position in which the rotation of the gear 70 about the first axis A1 is possible, in FIG. 9C, the gear 70 is shown in a locked position in which the rotation of the gear 70 is locked. In order to be moved between the open position and the blocking position, the gear 70 is mounted axially movable along the first axis A1 in the base body 26. Both in the open position and in the locked position, the gear 70 remains in meshing engagement with the intermediate gear 76. The main body 26 has a locking portion 80 which is formed corresponding to the gear 70. In the locking position, the gear 70 engages positively in the locking portion 80, whereby the rotation of the gear 70 is prevented about its own axis of rotation or about the first axis A1. The first component 12 cannot be moved toward the second component 14 or away from the second component 14 along the second axis A2 when the gear 70 is in the blocking position. Consequently, in this embodiment, the fixing device 40 is formed in the form of the locking portion 80.

In FIGS. 10A to 10C, a ninth embodiment of the device 22₉ according to the invention is shown by means of different views. The basic structure of the device 22₉ according to the ninth embodiment corresponds to the structure of the device 22₈ according to the eighth embodiment, however, the gear 70 is formed in this case as a bevel gear 82. Consequently, the first axis A1 and the further rotation axis T are not parallel to each other, but enclose an angle. As can be seen from FIGS. 10B and 10C, the fixing device 40 has a somewhat different structure. Due to the fact that the gear 70 is formed as a bevel gear 82, it cannot be moved axially along the first axis A1 without losing engagement with the intermediate gear 76. In the ninth embodiment, the fixing device 40, a locking element 84 which is axially on a rotatably connected to the bevel gear 82 bearing axis 86 slidably, but rotatably connected to the bearing shaft 86. The locking element 84 is biased in this case by means of a spring 88 in a locking position. The locking element 84 may be formed in the manner of a gear 70, but may also have a polygonal cross section. In the locked position, the locking element 84 engages positively in a corresponding locking portion 80 of the base body 26, so that the locking element 84 and consequently the gear 70 cannot be rotated about the first axis A1. As a result, the first component 12 cannot be moved toward or away from the second component 14 along the second axis A2.

As is apparent from FIGS. 10B and 10C, the locking member 84 can be moved against the force applied by the spring 88 by means of a wrench 90 in the open position in which the gear 70 is rotated and consequently the first component 12 to the second component 14 toward or from can be moved this way. If the gap dimension G is set, the wrench 90 only has to be pulled out of the gear 70, whereby the gear 70 is returned to the blocking position by the spring 88. As a result, the once set G is fixed.

While the invention has been illustrated and described as embodied in a vehicle, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A device for adjusting a first component and a second component of a passenger and/or goods transport means relative to each other, wherein the two components arranged adjacent to each other form a gap comprising:
a base body,
an adjusting element mounted in the base body and movable along a first axis and/or movable about the first axis in the base body,
an actuating body mounted in the base body and movable along a second axis mounted actuating body which cooperates with the adjusting element that the movement of the adjusting element along the first axis or about the first axis is converted into a movement of the actuating body and/or the adjusting element along the second axis, wherein the movement of the actuating body and/or the adjusting element along the second axis is transferable to the first component or the second component, and
a fixing device for fixing the adjusting element and the adjusting body in a selectable position.

2. The device according to claim 1,
wherein the adjusting element is designed as a screw.

3. The device according to claim 2,
wherein the fixing device is configured as a self-locking thread of the screw with a screw head.

4. The device according to claim 3,
wherein the actuating body, is mounted via a cantilever, and rotatable about a pivot point in the base body directed about a
pivot point perpendicular to the first axis and to the second axis,
and wherein the actuating body has a first contact surface for acting through the screw head of the screw, which is aligned substantially perpendicular to the first axis,
and wherein the adjusting body has a second contact surface for contacting the first component or the second component, which is aligned substantially perpendicular to the second axis.

5. The device according to claim 4,
wherein the adjusting body includes at least two, approximately L-shaped actuating body forming legs which are angled in the range of 45° to 135° to each other, wherein the pivot point at the connection point of the two legs is arranged and wherein the first contact surface is formed on one leg and the second contact surface formed on the other leg.

6. The device according to claim 5,
wherein at least one of the first and second contact surfaces are convexly curved, which causes in different rotational positions about the pivot point, the respective contact surface substantially perpendicular to first axis or second axis is aligned.

7. The device according to claim 6,
wherein the first contact surface is arranged at a smaller distance from the pivot point as compared to the second contact surface.

8. The device according to claim 1,
wherein the adjusting element is configured as a screw, wherein the adjusting body is formed as an eccentric body arranged on the screw.

9. The device according to claim 8, wherein the eccentric body has a helical bearing surface with a radius varying with respect to the first axis, the eccentric body being supported on a bearing portion of the base body.

10. The device according to claim 9,
wherein the fixing device has a friction portion arranged on the base body that cooperates with the eccentric body.

11. The device according to claim 1,
wherein the adjusting element further comprises a spindle and the actuating body a spindle nut and a scissor pair with two scissor members, wherein the spindle nut is rotatably fastened with the scissor pair,
wherein the first of the scissor members is rotatably fastened on the base body and the other of the scissor members is non-rotatably secured to a support body on which the first component or the second component can be placed, or the first of the scissor members is rotatably fastened to the base body and the other of the scissor members non-rotatably is fastened on the first component or the second component.

12. The device according to claim 1,
wherein the adjusting element comprises a spindle and the adjusting body on the spindle or about the spindle arranged spindle wedge, and the base body to a spindle wedge corresponding wedge portion, wherein the spindle wedge on the wedge portion is supported or vice versa.

13. The device according to claim 1,
herein the fixing device with the adjusting element rotatably and axially on the adjusting element displaceable locking element, wherein the locking element between a locking position in which the locking element Rotation of the adjusting element about the first axis locks, and an open position in which the locking element allows the rotation of the adjusting element is axially displaceable.

14. The device according to claim 1,
wherein the adjusting element that is rotatably mounted in the base body is configured as a gear, with which the actuating body configured as a rack movable along the second axis is in meshing engagement.

15. The device according to claim 14,
wherein between the gear and the rack rotatably mounted in the base body intermediate gear is arranged.

16. The device according to claim 15,
wherein the gear is formed as a bevel gear.

17. The device according to claim 14,
wherein the gear is axially movably mounted in the base body, wherein the gear between a locking position, in which the rotation of the adjusting element about the first axis is locked, and an open position in which the rotation of the adjusting element (32) is possible, is axially displaceable.

18. The device according to claim 17,
wherein the base body has a gear corresponding to the locking portion, in which the gear engages positively in the locked position.

19. A passenger and/or freight transport vehicle, comprising,
a first component and a second component, wherein the two components are arranged adjacent to each other to form a gap, and
a device according to claim 1, wherein the first component and the second component by means of the device are adjustable relative to each other, whereby the gap dimension of the gap is variable.

20. The device of claim 5, wherein the actuating body forming legs are angled at approximately 90°.
